(19) United States
(12) Patent Application Publication
(10) Pub. No.: US 2023/0221442 A1
(43) Pub. Date: Jul. 13, 2023

(54) Lidar Clocking Schemes For Power Management

(71) Applicant: Ouster, Inc., San Francisco, CA (US)

(72) Inventors: Tarek Al Abbas, Edinburgh (GB); Colin Steele, Edinburgh (GB); Robert Henderson, Edinburgh (GB)

(73) Assignee: Ouster, Inc., San Francisco, CA (US)

(21) Appl. No.: 18/094,049

(22) Filed: Jan. 6, 2023

Related U.S. Application Data
(60) Provisional application No. 63/297,660, filed on Jan. 7, 2022.

(51) Int. Cl. G01S 17/894; G01S 7/4865

(52) U.S. Cl. CPC G01S 17/894; G01S 7/4865

(57) ABSTRACT

Circuits, methods, and apparatus that can reduce clock induced current and voltage transients and emissions in lidar pixel arrays. A pixel array can include an array of pixels, where at any given time, different pixels in the pixel array perform different tasks and are clocked by clock signals having different phases or delays relative to each other. This temporal dispersion of tasks and clock signals can spread clock induced current and voltage transients and emissions throughout a clock cycle, thereby reducing their maximum amplitude.

### CROSS-REFERENCE TO RELATED APPLICATIONS

This application claims the benefit of U.S. provisional application No. 63/297,660, filed Jan. 7, 2022, which is incorporated by reference.

### BACKGROUND

This disclosure relates generally to lidar systems and more specifically to reducing clock noise in lidar systems.

Time of flight (ToF) based imaging is used in a number of applications, including range finding, depth profiling, and 3D imaging, such as light imaging, detection, and ranging (LiDAR, or lidar). Direct time-of-flight (dToF) measurement includes directly measuring the length of time between emitting radiation from emitter element(s) and sensing the radiation by detector element(s) after reflection from an object or other target. The distance to the target can be determined from the measured length of time. Indirect time of flight measurement includes determining the distance to the target by phase modulating the amplitude of the signals emitted by the emitter element(s) of the lidar system and measuring phases (e.g., with respect to delay or shift) of the echo signals received at the detector element(s) of the lidar system. These phases may be measured with a series of separate measurements or samples.

In specific applications, the sensing of the reflected radiation in either direct or indirect time of flight systems may be performed using an array of detectors, such as an array of Single Photon Avalanche Diodes (SPADs). One or more detectors may define a sensor (also referred to as a “pixel”) of a sensor array used to generate a lidar image for the depth (range) to objects for respective pixels.

When imaging a scene, ToF sensors (also referred to as photosensors) for lidar applications can include circuits that time-stamp and/or count incident photons as reflected from a target. Data rates can be compressed by histogramming timestamps. For instance, for each pixel, a histogram having bins (also referred to as “time bins”) corresponding to different ranges of photon arrival times can be stored in memory, and photon counts can be accumulated in different time bins of the histogram according to their arrival time. A time bin can correspond to a time range of, e.g., 1 ns, 2 ns, or the like. Some lidar systems may perform in-pixel histogramming of incoming photons using a clock-driven architecture and a limited memory block, which may provide a significant increase in histogramming capacity. However, since memory capacity is limited and typically cannot cover the desired distance range at once, such lidar systems may operate in “strobing” mode. “Strobing” refers to the generation of detector control signals (also referred to herein as “strobe signals” or “strobes”) to control the timing and/or duration of activation (also referred to herein as “detection windows” or “strobe windows”) of one or more detectors of the lidar system, such that photon detection and histogramming is performed sequentially over a set of different time windows, each corresponding to an individual distance subrange, so as to collectively define the entire distance range. In other words, partial histograms may be acquired for subranges or “time slices” corresponding to different sub-ranges of the distance range and then amalgamated into one full-range histogram. Thousands of time bins (each corresponding to respective photon arrival times) may typically be used to form a histogram sufficient to cover the typical time range of a lidar system (e.g., microseconds) with the typical time-to-digital converter (TDC) resolution (e.g., 50 to 100 picoseconds).

These circuits can be synchronous circuits that are driven by clock circuitry, including clock drivers. It can be desirable for these clock drivers to provide fast edges to facilitate accurate data transfers. But these fast edges can generate large supply current spikes, which can generate voltage transients on ground and power supply lines feeding the clock drivers. The resulting voltage transients can degrade the clock signals, cause electromagnet interference with associated and proximate circuits, and degrade system performance.

Thus, what is needed are circuits, methods, and apparatus that can reduce clock induced transients and emissions in lidar pixel arrays.

### SUMMARY

Accordingly, embodiments of the present invention provide circuits, methods, and apparatus that can reduce clock induced transients and emissions in lidar pixel arrays. An illustrative embodiment of the present invention can provide a pixel array the can include an array of pixels, where at any given time, different pixels in the pixel array perform different tasks and are clocked by clock signals having different phase-shifts relative to each other. This dispersion of tasks and clock signals can spread clock induced transients and emissions throughout a clock cycle, thereby reducing their maximum amplitude.

An illustrative embodiment of the present invention can provide pixel arrays having a number of groups of pixels, where each group of pixels can perform a series of two or more tasks in a recurring, serial pattern, and each group of pixels can be configured to perform different ones of the two or more tasks at a given time. For example, a first group of pixels can sequentially perform a first task and then a second task, while a second group of pixels can sequentially perform the second task and then the first task. That is, the tasks performed by the first group of pixels and the second group of pixels can be offset. Performance of the first task can generate clock induced transients and emissions, for example supply current spikes, having relatively large amplitudes, while performance of the second task can generate supply current spikes having relatively small amplitudes. Having the first group of pixels perform the first task while the second performs the second task, and then having the first group of pixels perform the second task while the second performs the first task, can generate supply current spikes having an averaged amplitude that is smaller than the supply current spikes associated with the first task, if all the pixels were to perform the first task simultaneously.

In another illustrative embodiment of the present invention, pixels can perform a series of more than two tasks in a recurring, serial pattern. For example, during a precharge task, bitlines in memory blocks in the pixels can be precharged. Subsequently, during a read task, the memory cells can drive stored values onto the bitlines. In a following modify task, the content of the memory cells can be modified by adding new data from the SPADs. During a write task, the new values on the bitlines can be written to the memory cells. In each of these precharge, read, modify, and write stages, the resulting supply current spikes can have a different amplitude. Accordingly, a first group of pixels can perform a precharge task, a second group of pixels can perform a read task, a third group of pixels can perform a modify task, while a fourth performs a write task. That is, for each group of pixels, the task being performed can be offset from each other such that each group of pixels performs a different task at any given time. As before, this can tend to average resulting supply current spikes to a level that is lower than the worst-case supply current spikes that would result if all groups of pixels performed the same task at the same time. In these and other embodiments of the present invention, at least approximately one-fourth of the pixels in a pixel array can be assigned to each of these first, second, third, and fourth groups of pixels. In these and other embodiments of the present invention, pixels or other circuits can perform three, five, or more than five recurring, sequential tasks. In these examples, pixels can be arranged as three, five, or more than five corresponding groups of pixels.

In these and other embodiments of the present invention, the clock signals for groups of pixels can be skewed or phase shifted relative to each other. As an example, a first clock signal can be provided to a first group of pixels. A second clock signal can be delayed by one-quarter cycle, 90 degrees, or π/2 radians and provided to a second group of pixels. A third clock signal can be delayed by one-half cycle, 180 degrees, or π radians and provided to a third group of pixels. A fourth clock signal can be delayed by three-quarters of cycle, 270 degrees, or 3π/2 radians and provided to a fourth group of pixels. These delays can disperse the resulting supply current spikes to four temporal locations for each clock cycle, thereby reducing the worst-case supply current spikes. In these and other embodiments of the present invention, different numbers of delays can be employed and the delays can have various durations. These durations can be fixed or they can be variable.

In these and other embodiments of the present invention, the above variations can be combined. As an example, different pixels in a pixel array can be assigned to perform one of a number of tasks and can be driven by a clock signal having one of a number of delays. In such an arrangement, different pixels in a group performing a first task can be driven with clocks having different phases. Alternatively, each pixel in a group performing a first task can be driven with a clock having a first phase.

As an example, groups of pixels can recurringly and sequentially perform precharge, read, modify, and write tasks. At a given time, a first group of pixels can perform a precharge task, a second group of pixels can perform a read task, a third group of pixels can perform a modify task, while a fourth performs a write task. Different pixels in each group of pixels can be clocked by clocks having different phases. During image reconstruction, compensation for offsets among tasks and phase shifts among clocks might be needed. Also, in some circumstances, a number of pixels, often adjacent pixels, can be combined in order to increase sensitivity of the pixel array at the expense of resolution. Where adjacent pixels have either their clocks phase shifted relative to each other or their tasks offset relative to each other, or both, compensation for the clock phase shift or task offset might be needed. These and other embodiments of the present invention can simplify the combining of pixels by positioning at least some pixels in each group of pixels adjacent to each other. Some or all of the adjacent pixels to be combined can receive a common clock.

The above task offset and clock phase-shift techniques can act to spread supply current spikes over time, therefore reducing their peak amplitudes. These supply current spikes can result from charge being stored in and removed from the capacitances distributed along the various clock, power supply and ground lines, and internal logic nodes. These changes in the charges stored in the distributed capacitances can tend to settle around a somewhat stable dynamic range. But it can take a few initial clock cycles for this to occur. Until the changes in the charges stored in the distributed capacitances settle, the supply current spikes can be comparatively large. Further, supply currents, supply current spikes, and other transient currents in the pixel array can flow through the resistances associated with traces for each of the power supply and ground lines. This can lead to an effective reduction in supply voltage seen by circuits in the dynamic array when the clock signals initially become active. The settling time associated with the supply current spikes and the initial supply voltage drop can cause errors during the first few initial clock cycles. Accordingly, embodiments of the present invention can incorporate a delay or other circuit to ignore pixel array results for a first number of clock cycles. The first number of clock cycles can be fixed, for example at two, five, nine, thirteen, or another number of clock cycles. Alternatively, the first number of clock cycles can be programmable, where the number is programmed during manufacturing, during operation of the lidar system utilizing the pixel array, or during another time.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 is a simplified block diagram of a Light Detection and Ranging (LiDAR, or lidar) system according to some embodiments.

FIG. 2 is a simplified block diagram of components of a time-of-flight measurement system or circuit according to some embodiments.

FIG. 3 illustrates the operation of a typical lidar system that may be improved by some embodiments.

FIG. 4 shows a histogram according to some embodiments.

FIG. 5 shows the accumulation of a histogram over multiple pulse trains for a selected pixel according to some embodiments.

FIG. 6 illustrates an example of a pixel for a pixel array according to an embodiment of the present invention.

FIG. 7 illustrates a timing diagram and resulting supply current spikes for a pixel according to an embodiment of the present invention.

FIG. 8 illustrates a portion of a pixel array according to an embodiment of the present invention.

FIG. 9 illustrates a timing diagram for a pixel array according to an embodiment of the present invention.

FIG. 10 illustrates circuitry that can be used to implement the signals shown in the timing diagram of FIG. 9.

FIG. 11 illustrates a timing diagram for a number of clocks that can be used to clock signals in a pixel array according to an embodiment of the present invention.

FIGS. 12A and 12B illustrates timing diagrams for the operation of a pixel array according to embodiments of the present invention.

FIG. 13 illustrates an example distribution of clock and timing signals among pixels in a pixel array according to an embodiment of the present invention.

FIG. 14 illustrates a pixel array having an increased sensitivity according to an embodiment of the present invention.

FIG. 15 illustrates an arrangement of timing signals and clock signals for a pixel array according to an embodiment of the present invention.

FIG. 16 illustrates initial conditions for a pixel array according to an embodiment of the present invention.

FIG. 17 illustrates initial conditions for a pixel array according to an embodiment of the present invention.

FIG. 18 illustrates a circuit that can be programmed for use in suppressing or ignoring a number of initial clock cycles in a pixel array according to an embodiment of the present invention.

FIG. 19 is a simplified illustration of an automobile in which multiple solid-state flash lidar sensors according to some embodiments are included at different locations along the vehicle.

### DETAILED DESCRIPTION

Embodiments of the present invention can provide circuits, methods, and apparatus that can reduce clock induced current and voltage transients and emissions in lidar pixel arrays. A pixel array can include an array of pixels, where at any given time, different pixels in the array perform different tasks and are clocked by clock signals having different phases or delays relative to each other. This dispersion of tasks and clock signals can spread clock induced current and voltage transients and emissions throughout a clock cycle, thereby reducing their maximum amplitude.

### 1. Example Lidar System

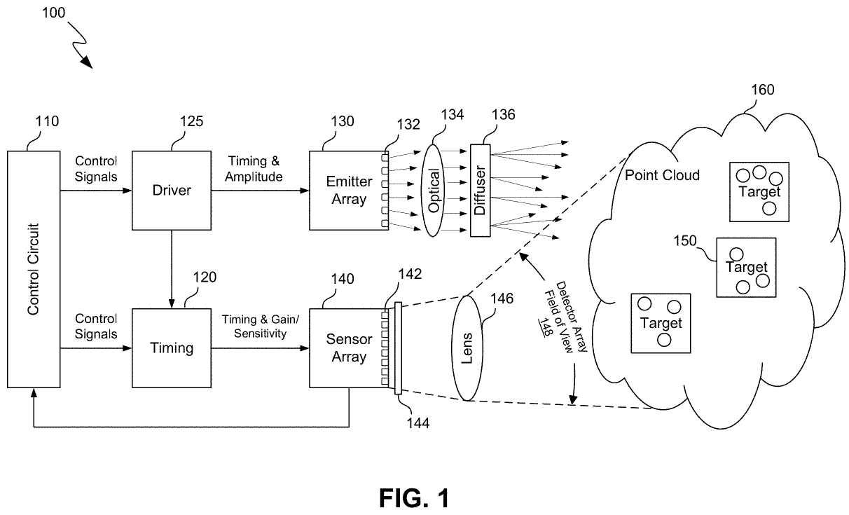

FIG. 1 illustrates an example light-based 3D sensor system 100, such as a Light Detection and Ranging (LiDAR, or lidar) system, in accordance with some embodiments of the invention. Lidar system 100 can include a control circuit 110, a timing circuit 120, driver circuitry 125, an emitter array 130 and a sensor array 140. Emitter array 130 can include a plurality of emitter units 132 arranged in an array (e.g., a one- or two-dimensional array) and sensor array 140 can include a plurality of sensors 142 arranged in an array (e.g., a one- or two-dimensional array). The sensors 142 can be depth sensors, such as time-of-flight (ToF) sensors. In some embodiments each sensor 142 can include, for example, an array of single-photon detectors, such as single photon avalanche diodes (SPADs). In some embodiments, each sensor 142 can be coupled to an in-pixel memory block (not shown) that accumulates histogram data for that sensor 142, and the combination of a sensor and in-pixel memory circuitry is sometimes referred to as a “pixel” 142. Each emitter unit 132 of the emitter array 130 can include one or more emitter elements that can emit a radiation pulse (e.g., light pulse) or continuous wave signal at a time and frequency controlled by a timing generator or driver circuitry 125. In some embodiments, the emitter units 132 can be pulsed light sources, such as LEDs or lasers such as vertical cavity surface emitting lasers (VCSELs) that emit a cone of light (e.g., infrared light) having a predetermined beam divergence.

Emitter array 130 can project pulses of radiation into a field of view of the lidar system 100. Some of the emitted radiation can then be reflected back from objects in the field, such as targets 150. The radiation that is reflected back can then be sensed or detected by the sensors 142 within the sensor array 140. Control circuit 110 can implement a processor that measures and/or calculates the distance to targets 150 based on data (e.g., histogram data) provided by sensors 142. In some embodiments control circuit 110 can measure and/or calculate the time of flight of the radiation pulses over the journey from emitter array 130 to target 150 and back to the sensors 142 within the sensor array 140 using direct or indirect time of flight (ToF) measurement techniques.

In some embodiments, emitter array 130 can include an array (e.g., a one- or two-dimensional array) of emitter units 132 where each emitter unit is a unique semiconductor chip having one or more individual VCSELs (sometimes referred to herein as emitter elements) formed on the chip. An optical element 134 and a diffuser 136 can be disposed in front of the emitter units such that light projected by the emitter units passes through the optical element 134 (which can include, e.g., one or more Fresnel lenses) and then through diffuser 136 prior to exiting lidar system 100. In some embodiments, optical element 134 can be an array of lenses or lenslets (in which case the optical element 134 is sometimes referred to herein as “lens array 134” or “lenslet array 134”) that collimate or reduce the angle of divergence of light received at the array and pass the altered light to diffuser 136. The diffuser 136 can be designed to spread light received at the diffuser over an area in the field that can be referred to as the field of view of the emitter array (or the field of illumination of the emitter array). In general, in these embodiments, emitter array 130, lens array 134 and diffuser 136 cooperate to spread light from emitter array 130 across the entire field of view of the emitter array. A variety of emitters and optical components can be used.

The driver circuitry 125 can include one or more driver circuits, each of which controls one or more emitter units. The driver circuits can be operated responsive to timing control signals with reference to a master clock and/or power control signals that control the peak power and/or the repetition rate of the light output by the emitter units 132. In some embodiments, each of the emitter units 132 in the emitter array 130 is connected to and controlled by a separate circuit in driver circuitry 125. In other embodiments, a group of emitter units 132 in the emitter array 130 (e.g., emitter units 132 in spatial proximity to each other or in a common column of the emitter array), can be connected to a same circuit within driver circuitry 125. Driver circuitry 125 can include one or more driver transistors configured to control the modulation frequency, timing, and/or amplitude of the light (optical emission signals) output from the emitter units 132.

In some embodiments, a single event of emitting light from the multiple emitter units 132 can illuminate an entire image frame (or field of view); this is sometimes referred to as a “flash” lidar system. Other embodiments can include non-flash or scanning lidar systems, in which different emitter units 132 emit light pulses at different times, e.g., into different portions of the field of view. The maximum optical power output of the emitter units 132 can be selected to generate a signal-to-noise ratio of the echo signal from the farthest, least reflective target at the brightest background illumination conditions that can be detected in accordance with embodiments described herein. In some embodiments, an optical filter (not shown) such as a bandpass filter can be included in the optical path of the emitter units 132 to control the emitted wavelengths of light.

Light output from the emitter units 132 can impinge on and be reflected back to lidar system 100 by one or more targets 150 in the field. The reflected light can be detected as an optical signal (also referred to herein as a return signal, echo signal, or echo) by one or more of the sensors 142 (e.g., after being collected by receiver optics 146), converted into an electrical signal representation (sometimes referred to herein as a detection signal), and processed (e.g., based on time-of-flight techniques) to define a 3-D point cloud representation 160 of a field of view 148 of the sensor array 140. In some embodiments, operations of lidar systems can be performed by one or more processors or controllers, such as control circuit 110.

Sensor array 140 includes an array of sensors 142. In some embodiments, each sensor 142 can include one or more photodetectors, e.g., SPADs. And in some particular embodiments, sensor array 140 can be a very large array made up of hundreds of thousands or even millions of densely packed SPADs. Receiver optics 146 and receiver electronics (including timing circuit 120) can be coupled to the sensor array 140 to power, enable, and disable all or parts of the sensor array 140 and to provide timing signals thereto. In some embodiments, sensors 142 can be activated or deactivated with at least nanosecond precision (supporting time bins of 1 ns, 2 ns, etc.), and in various embodiments, sensors 142 can be individually addressable, addressable by group, and/or globally addressable. The receiver optics 146 can include a bulk optic lens that is configured to collect light from the largest field of view that can be imaged by the lidar system 100, which in some embodiments is determined by the aspect ratio of the sensor array 140 combined with the focal length of the receiver optics 146.

In some embodiments, the receiver optics 146 can further include various lenses (not shown) to improve the collection efficiency of the sensors and/or an anti-reflective coating (also not shown) to reduce or prevent detection of stray light. In some embodiments, a spectral filter 144 can be positioned in front of the sensor array 140 to pass or allow passage of “signal” light (i.e., light of wavelengths corresponding to wavelengths of the light emitted from the emitter units) but substantially reject or prevent passage of non-signal light (i.e., light of wavelengths different from the wavelengths of the light emitted from the emitter units).

The sensors 142 of sensor array 140 are connected to the timing circuit 120. The timing circuit 120 can be phase-locked to the driver circuitry 125 of emitter array 130. The sensitivity of each of the sensors 142 or of groups of sensors 142 can be controlled. For example, when the detector elements include reverse-biased photodiodes, avalanche photodiodes (APD), PIN diodes, and/or Geiger-mode avalanche diodes (e.g., SPADs), the reverse bias can be adjusted. In some embodiments, a higher overbias provides higher sensitivity.

In some embodiments, control circuit 110, which can be, for example, a microcontroller or microprocessor, provides different emitter control signals to the driver circuitry 125 of different emitter units 132 and/or provides different signals (e.g., strobe signals) to the timing circuit 120 of different sensors 142 to enable/disable the different sensors 142 to detect the echo signal (or returning light) from the target 150. The control circuit 110 can also control memory storage operations for storing data indicated by the detection signals in a non-transitory memory or memory array that is included therein or is distinct therefrom.

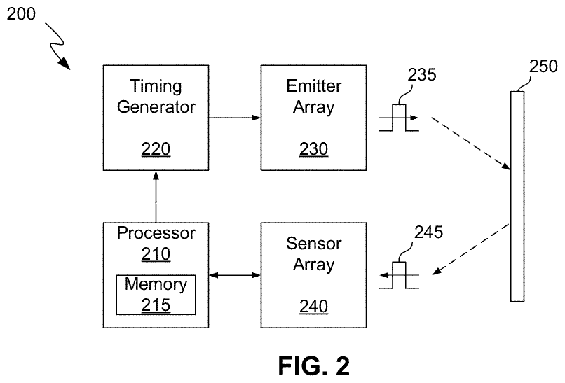

FIG. 2 further illustrates components of a ToF measurement system or circuit 200 in a lidar application in accordance with some embodiments described herein. The circuit 200 can include a processor circuit 210 (such as a digital signal processor (DSP)), a timing generator 220 that controls timing of the illumination source (illustrated by way of example with reference to a laser emitter array 230), and an array of sensors (illustrated by way of example with reference to a sensor array 240). The processor circuit 210 can also include a sequencer circuit (not shown in FIG. 2) that is configured to coordinate operation of emitter units within the illumination source (emitter array 230) and sensors within the sensor array 240.

The processor circuit 210 and the timing generator 220 can implement some of the operations of the control circuit 110 and the driver circuitry 125 of FIG. 1. Similarly, emitter array 230 and sensor array 240 can be representative of emitter array 130 and sensor array 140 in FIG. 1. The laser emitter array 230 can emit laser pulses 235 at times controlled by the timing generator 220. Light 245 from the laser pulses 235 can be reflected back from a target (illustrated by way of example as object 250) and can be sensed by sensor array 240. The processor circuit 210 implements a pixel processor that can measure or calculate the time of flight of each laser pulse 235 and its reflected light 245 over the journey from emitter array 230 to object 250 and back to the sensor array 240.

The processor circuit 210 can provide analog and/or digital implementations of logic circuits that provide the necessary timing signals (such as quenching and gating or strobe signals) to control operation of the single-photon detectors of the sensor array 240 and that process the detection signals output therefrom. For example, individual single-photon detectors of sensor array 240 can be operated such that they generate detection signals in response to incident photons only during the gating intervals or strobe windows that are defined by the strobe signals, while photons that are incident outside the strobe windows have no effect on the outputs of the single-photon detectors. More generally, the processor circuit 210 can include one or more circuits that are configured to generate detector control signals that control the timing and/or durations of activation of the sensor pixels 142 (or particular single-photon detectors therein), and/or to generate respective emitter control signals that control the output of light from the emitter units 132.

Detection events can be identified by the processor circuit 210 based on one or more photon counts indicated by the detection signals output from the sensor array 240, which can be stored in a non-transitory memory 215. In some embodiments, the processor circuit 210 can include a correlation circuit or correlator that identifies detection events based on photon counts (referred to herein as correlated photon counts) from two or more single-photon detectors within a predefined window (time bin) of time relative to one another, referred to herein as a correlation window or correlation time, where the detection signals indicate arrival times of incident photons within the correlation window. Since photons corresponding to the optical signals output from the emitter array 230 (also referred to as signal photons) can arrive relatively close in time with each other, as compared to photons corresponding to ambient light (also referred to as background photons), the correlator can be configured to distinguish signal photons based on respective times of arrival being within the correlation time relative to one another. Such correlators and strobe windows are described, for example, in U.S. Patent Application Publication No. 2019/0250257, entitled “Methods and Systems for High-Resolution Long Range Flash Lidar,” which is incorporated by reference herein in its entirety for all purposes.

The processor circuit 210 can be small enough to allow for three-dimensionally stacked implementations, e.g., with the sensor array 240 “stacked” on top of processor circuit 210 (and other related circuits) that is sized to fit within an area or footprint of the sensor array 240. For example, some embodiments can implement the sensor array 240 on a first substrate, and transistor arrays of the processor circuit 210 on a second substrate, with the first and second substrates/wafers bonded in a stacked arrangement, as described for example in U.S. Patent Application Publication No. 2020/0135776, entitled “High Quantum Efficiency Geiger-Mode Avalanche Diodes Including High Sensitivity Photon Mixing Structures and Arrays Thereof,” the disclosure of which is incorporated by reference herein in its entirety for all purposes.

The pixel processor implemented by the processor circuit 210 can be configured to calculate an estimate of the average ToF aggregated over hundreds or thousands of laser pulses 235 and photon returns in reflected light 245. The processor circuit 210 can be configured to count incident photons in the reflected light 245 to identify detection events (e.g., based on one or more SPADs within the sensor array 240 that have been “triggered”) over a laser cycle (or portion thereof).

The timings and durations of the detection windows can be controlled by a strobe signal (Strobe#i or Strobe<i>). Many repetitions of Strobe#i can be aggregated (e.g., in the pixel) to define a sub-frame for Strobe#i, with subframes i=1 to n defining an image frame. Each sub-frame for Strobe#i can correspond to a respective distance sub-range of the overall imaging distance range. In a single-strobe system, a sub-frame for Strobe#1 can correspond to the overall imaging distance range and is the same as an image frame since there is a single strobe. The time between emitter unit pulses (which defines a laser cycle, or more generally emitter pulse frequency) can be selected to define or can otherwise correspond to the desired overall imaging distance range for the ToF measurement system 200. Accordingly, some embodiments described herein can utilize range strobing to activate and deactivate sensors for durations or “detection windows” of time over the laser cycle, at variable delays with respect to the firing of the laser, thus capturing reflected correlated signal photons corresponding to specific distance sub-ranges at each window/ frame, e.g., to limit the number of ambient photons acquired in each laser cycle.

The strobing can turn off and on individual photodetectors or groups of photodetectors (e.g., for a pixel), e.g., to save energy during time intervals outside the detection window. For instance, a SPAD or other photodetector can be turned off during idle time, such as after an integration burst of time bins and before a next laser cycle. As another example, SPADs can also be turned off while all or part of a histogram is being read out from non-transitory memory 215. Yet another example is when a counter for a particular time bin reaches the maximum value (also referred to as “bin saturation”) for the allocated bits in the histogram stored in non-transitory memory 215. A control circuit can provide a strobe signal to activate a first subset of the sensors while leaving a second subset of the sensors inactive. In addition or alternatively, circuitry associated with a sensor can also be turned off and on as specified times.

### 2. Detection of Reflected Pulses

The sensors be arranged in a variety of ways for detecting reflected pulses. For example, the sensors can be arranged in an array, and each sensor can include an array of photodetectors (e.g., SPADs). A signal from a photodetector indicates when a photon was detected and potentially how many photons were detected. For example, a SPAD can be a semiconductor photodiode operated with a reverse bias voltage that generates an electric field of a sufficient magnitude that a single charge carrier introduced into the depletion layer of the device can cause a self-sustaining avalanche via impact ionization. The initiating charge carrier can be photo-electrically generated by a single incident photon striking the high field region. The avalanche is quenched by a quench circuit, either actively (e.g., by reducing the bias voltage) or passively (e.g., by using the voltage drop across a serially connected resistor), to allow the device to be “reset” to detect other photons. This single-photon detection mode of operation is often referred to as “Geiger Mode,” and an avalanche can produce a current pulse that results in a photon being counted. Other photodetectors can produce an analog signal (in real time) proportional to the number of photons detected. The signals from individual photodetectors can be combined to provide a signal from the sensor, which can be a digital signal. This signal can be used to generate histograms.

### 2.1. Time-of-Flight Measurements and Detectors

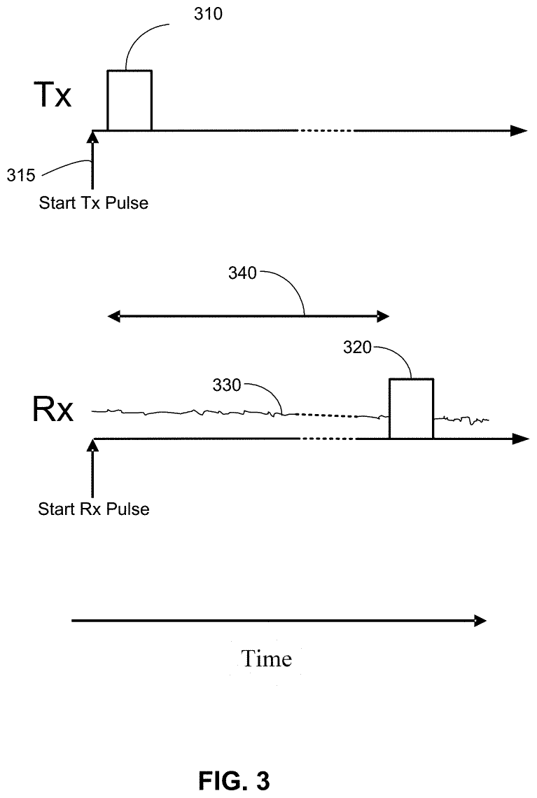

FIG. 3 illustrates the operation of a typical lidar system that may be improved by some embodiments. A laser or other emitter (e.g., within emitter array 230 or emitter array 130) generates a light pulse 310 of short duration. The horizontal axis represents time and the vertical axis represents power. An example laser pulse duration, characterized by the full-width half maximum (FWHM), is a few nanoseconds, with the peak power of a single emitter being around a few watts. Embodiments that use side emitter lasers or fiber lasers may have much higher peak powers, while embodiments with small diameter VCSELs could have peak powers in the tens of milliwatts to hundreds of milliwatts.

A start time 315 for the emission of the pulse does not need to coincide with the leading edge of the pulse. As shown, the leading edge of light pulse 310 may be after the start time 315. One may want the leading edge to differ in situations where different patterns of pulses are transmitted at different times, e.g., for coded pulses. In this example, a single pulse of light is emitted. In some embodiments, a sequence of multiple pulses can be emitted, and the term “pulse train” as used herein refers to either a single pulse or a sequence of pulses.

An optical receiver system (which can include, e.g., sensor array 240 or sensor array 140) can start detecting received light at the same time as the laser is started, i.e., at the start time. In other embodiments, the optical receiver system can start at a later time, which is at a known time after the start time for the pulse. The optical receiver system detects background light 330 initially and after some time detects the laser pulse reflection 320. The optical receiver system can compare the detected light intensity against a threshold to identify the laser pulse reflection 320. Where a sequence of pulses are emitted, the optical receiver system can detect each pulse. The threshold can distinguish the background light 330 from light corresponding to the laser pulse reflection 320.

The time-of-flight 340 is the time difference between the pulse 310 being emitted and the reflected pulse 320 being received. The time difference can be measured by subtracting the emission time of the pulse 310 (e.g., as measured relative to the start time) from a received time of the reflected pulse 320 (e.g., also measured relative to the start time). The distance to the target can be determined as half the product of the time-of-flight and the speed of light. Pulses from the laser device reflect from objects in the scene at different times, depending on start time and distance to the object, and the sensor array detects the pulses of reflected light.

### 2.2. Histogram Signals from Photodetectors

One mode of operation of a lidar system is time-correlated single photon counting (TCSPC), which is based on counting single photons in a periodic signal. This technique works well for low levels of periodic radiation which is suitable in a lidar system. This time correlated counting may be controlled by a periodic signal, e.g., from timing generator 220.

The frequency of the periodic signal can specify a time resolution within which data values of a signal are measured. For example, one measured value can be obtained for each photosensor per cycle of the periodic signal. In some embodiments, the measurement value can be the number of photodetectors that triggered during that cycle. The time period of the periodic signal corresponds to a time bin, with each cycle being a different time bin.

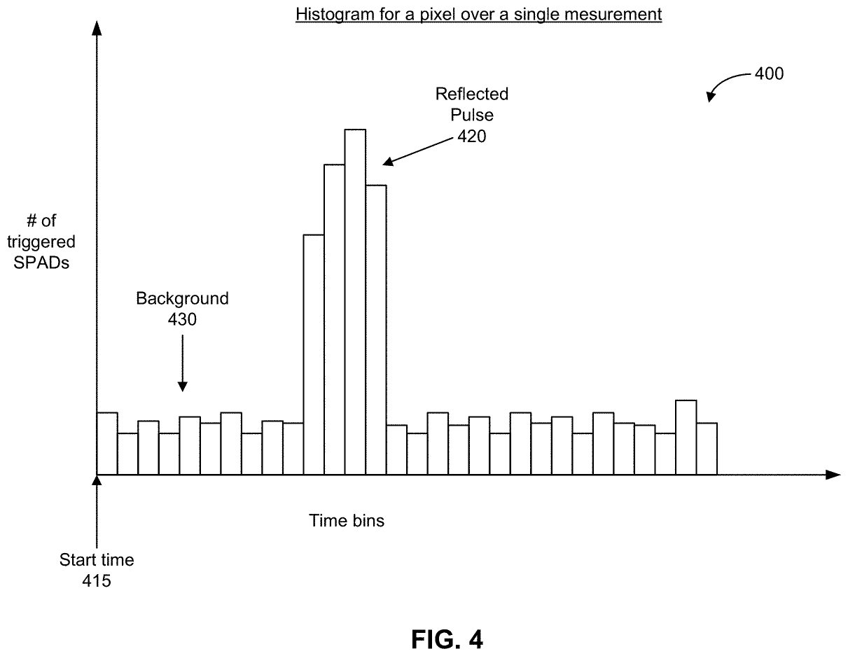

FIG. 4 shows a histogram 400 according to some embodiments described herein. The horizontal axis corresponds to time bins as measured relative to start time 415. As described above, start time 415 can correspond to a start time for an emitted pulse train. Any offsets between rising edges of the first pulse of a pulse train and the start time for either or both of a pulse train and a detection time interval can be accounted for when determining the received time to be used for the time-of-flight measurement. In this example, the sensor pixel includes a number of SPADs, and the vertical axis corresponds to the number of triggered SPADs for each time bin. Other types of photodetectors can also be used. For instance, in embodiments where APDs are used as photodetectors, the vertical axis may correspond to an output of an analog-to-digital converter (ADC) that receives the analog signal from an APD. It is noted that APDs and SPADS can both exhibit saturation effects. Where SPADs are used, a saturation effect can lead to dead time for the pixel (e.g., when all SPADs in the pixel are immediately triggered and no SPADs can respond to later-arriving photons). Where APDs are used, saturation can result in a constant maximum signal rather than the dead-time based effects of SPADs. Some effects can occur for both SPADs and APDs, e.g., pulse smearing of very oblique surfaces may occur for both SPADs and APDs.

The counts of triggered SPADs for each of the time bins correspond to the different bars in histogram 400. The counts at the early time bins are relatively low and correspond to background noise 430. At some point, a reflected pulse 420 is detected. The corresponding counts are much larger and may be above a threshold that discriminates between background and a detected pulse. The reflected pulse 420 results in increased counts in four time bins, which might result from a laser pulse of a similar width, e.g., a 4 ns pulse when time bins are each 1 ns.

The temporal location of the time bins corresponding to reflected pulse 420 can be used to determine the received time, e.g., relative to start time 415. In some embodiments, matched filters can be used to identify a pulse pattern, thereby effectively increasing the signal-to-noise ratio and allowing a more accurate determination of the received time. In some embodiments, the accuracy of determining a received time can be less than the time resolution of a single time bin. For instance, for a time bin of 1 ns, a resolution of one time bin would correspond to a distance about 15 cm. However, it can be desirable to have an accuracy of only a few centimeters.

Accordingly, a detected photon can result in a particular time bin of the histogram being incremented based on its time of arrival relative to a start signal, e.g., as indicated by start time 415. The start signal can be periodic such that multiple pulse trains are sent during a measurement. Each start signal can be synchronized to a laser pulse train, with multiple start signals causing multiple pulse trains to be transmitted over multiple laser cycles (also sometimes referred to as “shots”). Thus, a time bin (e.g., from 200 to 201 ns after the start signal) would occur for each detection interval. The histogram can accumulate the counts, with the count of a particular time bin corresponding to a sum of the measured data values all occurring in that particular time bin across multiple shots. When the detected photons are histogrammed based on such a technique, the result can be a return signal having a signal to noise ratio greater than that from a single pulse train by the square root of the number of shots taken.

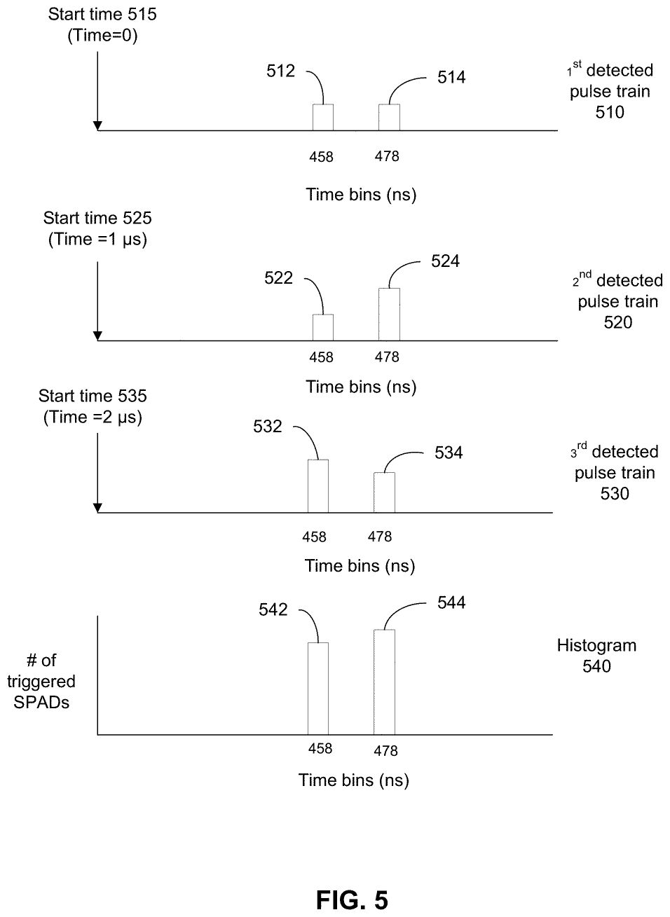

FIG. 5 shows the accumulation of a histogram over multiple pulse trains for a selected pixel according to some embodiments described herein. FIG. 5 shows three detected pulse trains 510, 520 and 530. Each detected pulse train corresponds to a transmitted pulse train that has a same pattern of two pulses separated by a same amount of time. Thus, each detected pulse train has a same pulse pattern, as shown by two time bins having an appreciable value. Counts for other time bins are not shown for simplicity of illustration, although the other time bins may have non-zero values (generally lower than the values in time bins corresponding to detected pulses).

In the first detected pulse train 510, the counts for time bins 512 and 514 are the same. This can result from a same (or approximately the same) number of photodetectors detecting a photon during each of the two time bins, or approximately the same number of photons being detected during the two time bins, depending on the particular photodetectors used. In other embodiments, more than one consecutive time bin can have a non-zero value; but for ease of illustration, individual nonzero time bins have been shown.

Time bins 512 and 514 respectively occur 458 ns and 478 ns after start time 515. The displayed counters for the other detected pulse trains occur at the same time bins relative to their respective start times. In this example, start time 515 is identified as occurring at time 0, but the actual time is arbitrary. The first detection interval for the first detected pulse train can be 1 μs. Thus, the number of time bins measured from start time 515 can be 1,000. After, this first detection interval ends, a new pulse train can be transmitted and detected. The start and end of the different time bins can be controlled by a clock signal, which can be part circuitry that acts as a time-to-digital converter (TDC).

For the second detected pulse train 520, the start time 525 is at 1 μs, at which time the second pulse train can be emitted. Time between start time 515 and start time 525 can be long enough that any pulses transmitted at the beginning of the first detection interval would have already been detected, and thus not cause confusion with pulses detected in the second detection interval. For example, if there is not extra time between shots, then the circuitry could confuse a retroreflective stop sign at 200 m with a much less reflective object at 50 m (assuming a shot period of about 1 us). The two detection time intervals for pulse trains 510 and 520 can be the same length and have the same relationship to the respective start time. Time bins 522 and 524 occur at the same relative times of 458 ns and 478 ns as time bins 512 and 514. Thus, when the accumulation step occurs, the corresponding counters can be added. For instance, the counter values at time bin 512 and 522 can be added together.

For the third detected pulse train 530, the start time 535 is at 2 μs, at which time the third pulse train can be emitted. Time bin 532 and 534 also occur at 458 ns and 478 ns relative to start time 535. The counts for corresponding pulses of different pulse trains may have different values even though the emitted pulses have a same power, e.g., due to the stochastic nature of the scattering process of light pulses off of objects.

Histogram 540 shows an accumulation of the counts from three detected pulse trains 510, 520, 530 at time bins 542 and 544, which also correspond to 458 ns and 478 ns. Histogram 540 can have fewer time bins than were measured during the respective detection intervals, e.g., as a result of dropping time bins in the beginning or the end of the detection interval or time bins having values less than a threshold. In some implementations, about 10-30 time bins can have appreciable values, depending on the pattern for a pulse train.

As examples, the number of pulse trains emitted during a measurement to create a single histogram can be around 1-40 (e.g., 24), but can also be much higher, e.g., 50, 100, 500, or 1000. Once a measurement is completed, the counts for the histogram can be reset, and another set of pulse trains can be emitted to perform a new measurement. In various embodiments and depending on the number of detection intervals in the respective measurement cycles, measurements can be performed, e.g., every 25, 50, 100, or 500 μs. In some embodiments, measurement intervals can overlap, e.g., so that a given histogram corresponds to a particular sliding window of pulse trains. In such an example, memory can be provided for storing multiple histograms, each corresponding to a different time window. Any weights applied to the detected pulses can be the same for each histogram, or such weights could be independently controlled.

### 3. Pixel Operation

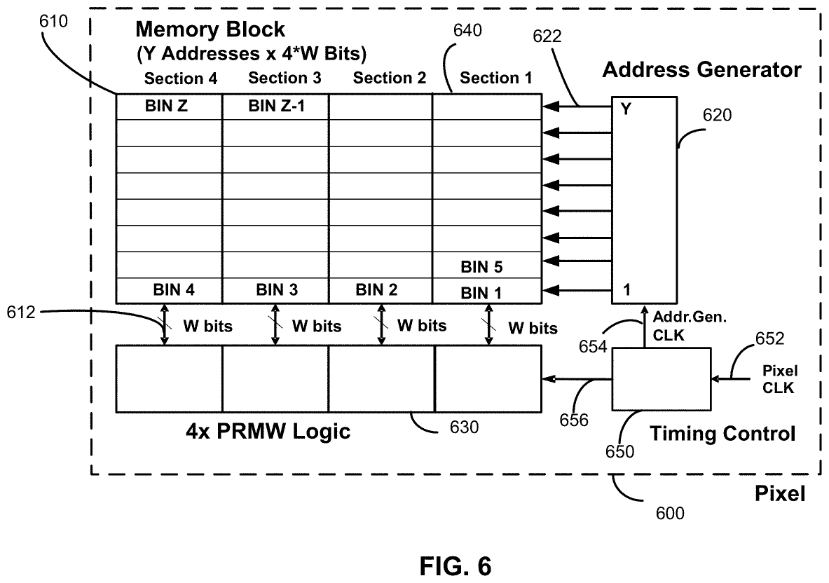

In some embodiments of the present invention, detector pixel 600, or more simply pixel 600, can include circuits that implement a memory block 610, a memory controller, such as PRMW logic circuits 630, an address generator 620, and timing control circuit 650 (all shown in FIG. 6.) Pixel 600 can include one or more photodetectors, such as SPADs, as well as other circuits or components (not shown.) Pixel 600 can be used as sensor 142 (shown in FIG. 1.)

FIG. 6 illustrates an example of a pixel according to an embodiment of the present invention. Pixel 600 can include an Y×4W memory block 610. Memory block 610 can include an array of memory cells arranged in Y rows and 4W columns, where the 4W columns are arranged as four memory banks 640 or sections, each having W memory cells. As shown in FIG. 6, timing control circuit 650 can receive a pixel clock on line 652. Timing control circuit 650 can provide an address generator clock on line 654 and pre-charge, read, modify, and write signals on lines 656 to PRMW logic circuits 630. Memory block 610 can be addressed using address generator 620 that provides Y row addresses on lines 622. Pixel 600 can include four PRMW logic circuits 630 of W bits each for a total of 4W bits, corresponding to the number of bitlines 612 or columns in memory block 610. In this configuration, four bins can be stored in each row of memory block 610. In these and other embodiments of the present invention, Y can have a value of 32, 36, 40, 64, or other value, while W can have a value of 8, 10, 12, 16, or other value. Memory block 610 can be divided into two, three, five, or more than five sections with a corresponding number of PRMW logic circuits 630.

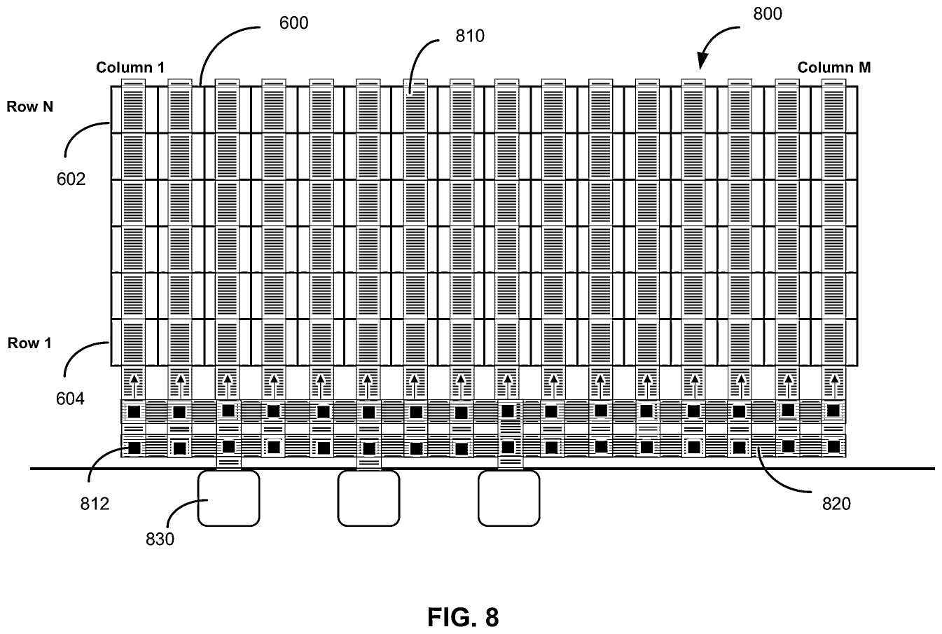

Pixels 600 in pixel array 800 (shown in FIG. 8) can histogram events detected from one or more SPADs following an emitted pulse from emitter array 230 (shown in FIG. 2.) That is, the number of detected events from one or more SPADs can be time-sliced into bins and accumulated in memory block 610. For example, the number of detected SPAD events from four preceding bins can be stored in a temporary memory in the PRMW logic circuits 630 or other related circuit. Pixel 600 can perform a series of tasks, wherein during a first clock cycle, the PRMW logic circuits 630, under the control of timing control circuit 650, can perform a precharge task, where bitlines 612 for memory block 610 can be precharged. During a second clock cycle, the memory cells in the addressed row can be read by PRMW logic circuits 630. Bin counts stored in the addressed row can be modified by the PRMW logic circuits 630 by adding values from the temporary memory to the read value. The PRMW logic circuits 630 can then perform a write task to write the modified bin counts back to the memory cells for the four bins in the addressed row in memory block 610. Further details of pixel 600 are described, for example, in U.S. Patent Application Publication No. 63/216,580, entitled “Highly Parallel Large Memory Histogramming Pixel for Direct Time of Flight Lidar,” the disclosure of which is incorporated by reference herein in its entirety for all purposes.

### 4. Supply Current Spikes Generated in Pixel Array

In this example, clock signals can be provided to address generator 620 and PRMW logic circuits 630. These clock signals can drive logic gates that form address generator 620 and PRMW logic circuits 630. As the clock signals and logic gates change states, their various associated capacitances, such as gate capacitances, trace capacitances, and others, can be charged and discharged. This transfer of charge can generate currents that can be supplied by and returned to the power supplies and grounds for pixel 600. These generated currents can cause current spikes, which can flow through resistances and inductances of the power supply and ground lines, thereby causing voltage spikes. Voltage spikes can have high-frequency components that can cause electromagnetic interference in pixel 600, as well as nearby pixels 600 and other nearby and associated circuits, thereby causing image and time-of-flight artifacts and otherwise degrading system performance. An example is shown in the following figure.

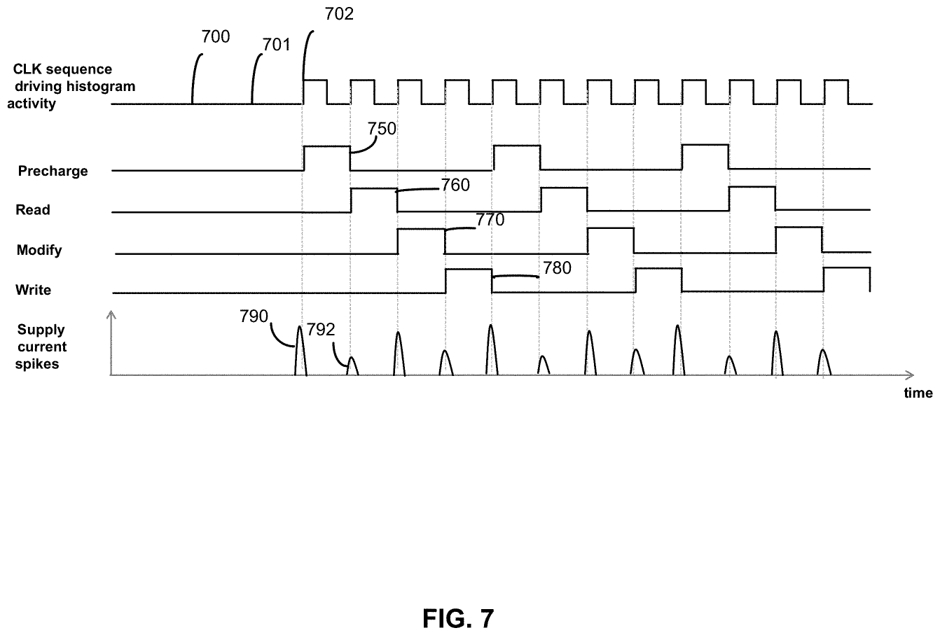

FIG. 7 illustrates a timing diagram and resulting supply current spikes for a pixel according to an embodiment of the present invention. Clock 700 can be held at a constant level during time 701 and can begin toggling at time 702. Time 701 can be a subframe between individual pulses emitted by emitter array 230 (shown in FIG. 2), or time 701 can be the end of a frame where histogram data is read from the memory blocks 610 in pixels 600 (both shown in FIG. 6) in pixel array 800 (shown in FIG. 8) and provided for use in image processing. Initially during a first clock cycle, a precharge pulse 750 can precharge bitlines 612 for memory banks 640 in memory block 610. Stored values can be read from the addressed four bins in the row selected by address generator 620 during read pulse 760, which can occur during a second clock cycle. During a third clock cycle, bin counts can be modified during modify pulse 770 by adding the values stored in the temporary memory in or associated with PRMW logic circuits 630 (shown in FIG. 6.) During the fourth clock cycle, the newly updated bin counts can be written to the memory cells for the bins in the addressed row during write pulse 780.

Transitions of clock 700, along with transitions in resulting logic signals, can generate supply current spikes 790. Supply current spikes 790 can have varying amplitudes depending on several factors. For example, supply current spikes 790 can be larger for faster circuits, more complicated circuits, or circuits where a relatively large number of gates change state. As a result, supply current spikes 790 and 792 can have different maximum amplitudes. Voltage spikes or transients that result from supply current spikes 790 can also be larger at circuits that are further from a low impedance point, such as a bonding pad for the power supply or ground, due to routing trace resistances and inductances. An example is shown in the following figure.

FIG. 8 illustrates a portion of a pixel array according to an embodiment of the present invention. Some or all of pixel array 800 can be formed as an integrated circuit that can include a number of pads 830. In these and other embodiments of the present invention, pixel array 800 can be used as sensor array 140 (shown in FIG. 1) or sensor array 240 (shown in FIG. 2.) Pads 830 can be used to connect power supplies, ground, or signals from outside sources to pixel array 800. For example, pads 830 can provide power supplies and grounds on lateral bus lines 820, through vias 812 to vertical bus lines 810, where they can provide power to pixels 600. In this example, pixel 602 in row N can be positioned further away from pad 830 as compared to pixel 604 in row 1. This can cause the resistance and inductance of a power supply or ground line to be larger for pixel 602 as compared to pixel 604. As a result, voltage spikes, transients, and voltage drops (IR drops) resulting from supply current spikes 790 (shown in FIG. 7) can be expected to be larger at pixel 602 as compared to pixel 604.

### 5. Offsetting Tasks to Reduce Peak Supply Current Spikes

Again, these voltage spikes resulting from supply current spikes 790 can cause data errors, generate electromagnetic interference, cause image and time-of-flight artifacts, and otherwise degrade system performance. Accordingly, embodiments of the present invention provide circuits, methods, and apparatus to reduce a maximum amplitude of supply current spikes 790.

Specifically, in these and other embodiments of the present invention, there can be a difference in amplitude among supply current spikes 790 that are generated by the different precharge, read, modify, and write tasks. This difference can be advantageously used to average amplitudes of supply current spikes 790, thereby reducing their maximum amplitude. As an example, a supply current spike 790 at the start of a precharge pulse 750 can be larger than supply current spike 792 at a start of read pulse 760 (all shown in FIG. 7.) If each pixel 600 in column 1 of pixel array 800 performs a precharge operation at the same time, the supply current spike 790 at pixel 602 could have a large maximum amplitude. Accordingly, embodiments of the present invention can vary the timing of precharge and the read, modify, and write tasks among the rows of pixel 600. As an example, one fourth of the rows of pixels 600 in pixel array 800 can perform a precharge task, another fourth can perform a read task, another fourth can perform a modify task, while the last fourth performs a write task. This distribution of tasks among pixels 600 in each column of pixel array 800 can tend to average supply current spikes 790 and 792 such that the resulting supply current spikes have a smaller maximum amplitude. A timing diagram illustrating this is shown in the following figure.

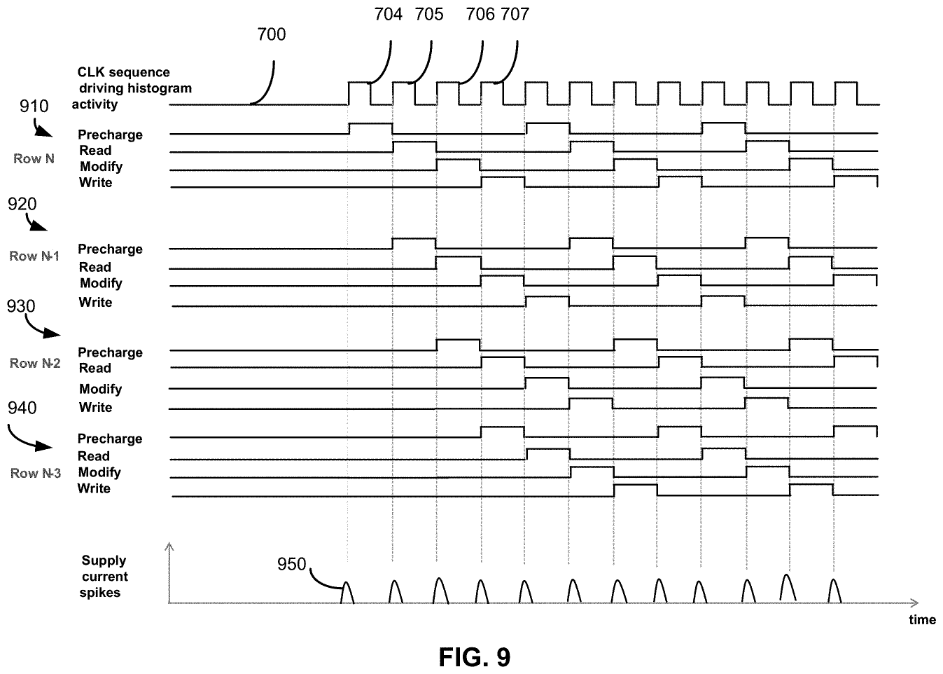

FIG. 9 illustrates a timing diagram for a pixel array according to an embodiment of the present invention. Clock 700 can drive precharge, read, modify, and write signals for the rows of pixels 600 (shown in FIG. 8.) In this example, each row of pixels 600 can have a different set of timing signals 910, 920, 930, or 940, though in these and other embodiments of the present invention, multiple rows can share a set of signals. In this example, row N can be driven by timing signals 910 such that row N performs a precharge task during a first clock cycle 704. Row N-1 can be driven by timing signals 920 such that row N-1 performs a precharge task during a second clock cycle 705. Row N-2 can be driven by timing signals 930 such that row N-2 performs a precharge task during a third clock cycle 706. Row N-2 can be driven by timing signals 940 such that row N-3 performs a precharge task during a fourth clock cycle 707. Subsequent tasks in the order of precharge, read, modify, and write, can be performed in a consecutive fashion in each row. This group of tasks can be repeated in a recurring manner. In this example, one fourth of the rows can perform a precharge task, one fourth of the rows can perform or read task, one fourth of the rows can form a modify task, and one fourth of the rows can perform a write task during a given clock cycle (following the first three initial clock cycles.) This can result in a balance in amplitude of supply current spikes 950, thereby resulting in a lower maximum amplitude as compared to supply current spikes 790 in FIG. 7.

As a result of different pixels (i.e., by row) performing different operations at different times, some pixels might modify and write values to one set of time bins (e.g., 11-14) in a collective operation, while another set of pixels (e.g., a different row) can modify and write values for a different set of time bins (e.g., 12-15). This is due to an offset in which set of time bins are currently being read, modified, and written by different pixels as a result of when a pixel first has a precharge signal. Once a pixel receives the precharge signal at a given time bin, e.g., corresponding to time bin 3 (clock cycle 706), then that specified the sets of 4 time bins that will be modified in parallel. For row N-2, the set of time bins would be 3-6, 7-10, and so one. A first set of time bins can be ignored or not used for histogramming for pixels that do not use those initial time bins.

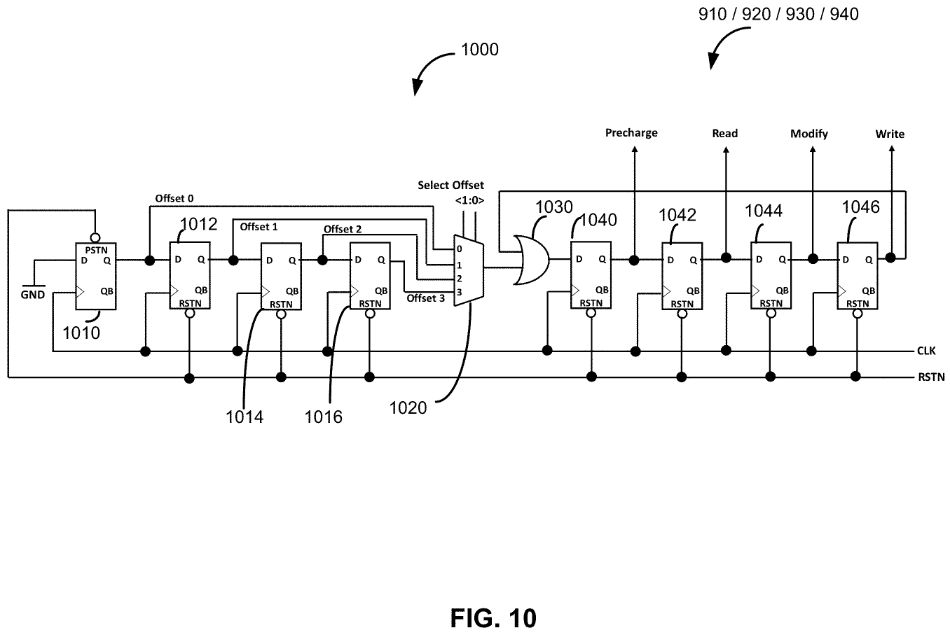

FIG. 10 illustrates circuitry that can be used to implement the signals shown in the timing diagram of FIG. 9. Timing circuit 1000 can be repeated four times, where each instance of timing circuit 1000 generates precharge, read, modify, and write signals for one fourth of the rows of pixels 600 in pixel array 800 (shown in FIG. 8.) Alternatively, timing circuit 1000 can be repeated for a row or group of rows that share timing signals. Alternatively, this circuit can be located in timing control circuit 650 in pixel 600 (both shown in FIG. 6.) The clock signal on line CLK can be the pixel clock received by timing control circuit 650 on line 652 (shown in FIG. 6.) Timing circuit 1000 can provide the precharge, read, modify, and write signals on lines 656 (shown in FIG. 6) to the PRMW logic circuits 630.

In this example, a reset event of a low signal on line RSTN can drive output Q of register 1010 high, while the output Q of the remaining registers can be driven low. The output Q of register 1010 can be referred to as a token. At this time, the Offset 0 signal at the 0 input of multiplexer 1020 is high, while the remaining inputs to multiplexer 1020 are low. If input 0 is selected at multiplexer 1020, the high level (token) can propagate through OR gate 1030 to the input of register 1040. At a first clock rising edge, the Q output of register 1040 can go high and the rows of pixels that are connected to this timing circuit 1000 can begin a precharge task. Accordingly, such an instance of timing circuit 1000 can be used to generate timing signals 910 shown in FIG. 9. On subsequent clock cycles, the token can pass from register 1040 to register 1042, from register 1042 to register 1044, and from register 1044 to register 1046, before returning to register 1040. In this way, signals for the consecutive tasks of precharge, read, modify, and write can be recurringly generated.

Alternatively, if multiplexer input 1 is selected at multiplexer 1020, during a second clock rising edge, the output Q of register 1010 can go low, and the output Q of register 1012 can go high. This high, the token, can propagate through multiplexer 1020 and OR gate 1030. On the following clock cycle, the precharge signal at the output Q at 1040 can go high. Accordingly, this instance of timing circuit 1000 can be used to generate timing signals 940 shown in FIG. 9. In this way, an instance of timing circuit 1000 where multiplexer input 2 is selected can be used to generate timing signals 930, and an instance of timing circuit 1000 where multiplexer input 3 is selected can be used to generate timing signals 920 shown in FIG. 9.

### 6. Phase-Shifting Clocks to Reduce Peak Supply Current Spikes

As shown in FIG. 9, resulting supply current spikes 950 can be at least somewhat similar in amplitude and lower than a peak amplitude of supply current spikes 790. However, the energy of these supply current spikes 950 might remain near rising edges of clock 700. Accordingly, embodiments of the present invention can provide circuits, methods, and apparatus whereby supply current spikes 950 are distributed to various temporal locations throughout each clock cycle. Examples of this are shown in the following figures.

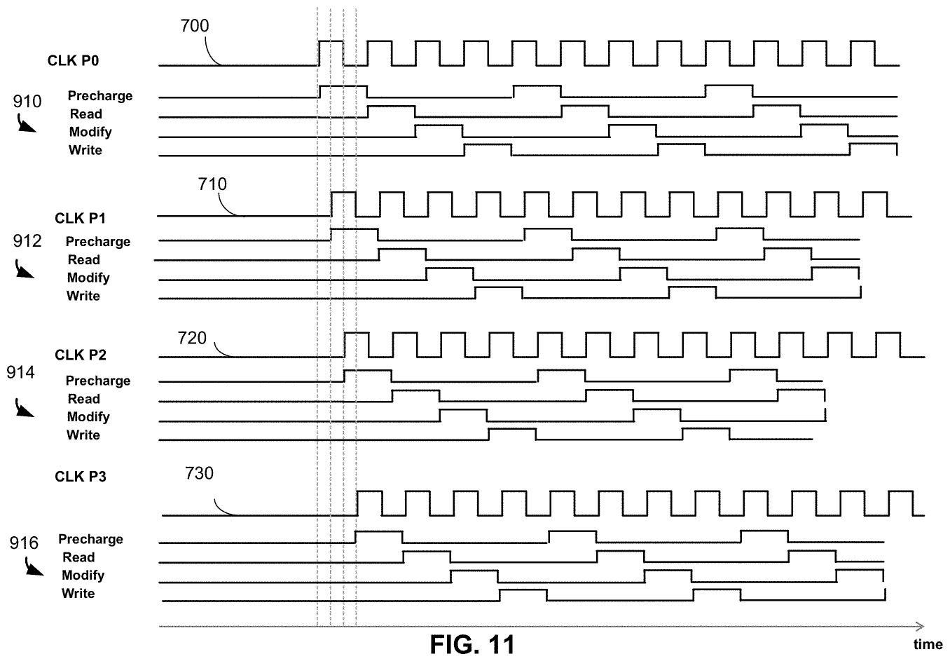

FIG. 11 illustrates a timing diagram for a number of clocks that can be used to clock timing signals in a pixel array according to an embodiment of the present invention. Clock 700 can be delayed to generate clock 710. Clock 710 can similarly be delayed to generate clock 720. Clock 720 can be similarly delayed to form clock 730. Alternatively, clock 700 can be delayed by differing amounts to generate each of clock 710, clock 720, and clock 730. These clock signals can be generated in many ways, for example using a ring oscillator or other circuit. In this example, four clock signals are shown, though in these or other embodiments of the present invention, two, three, five, or more than five clock signals can be utilized. In this example, each signal can be delayed or separated by one-quarter of a clock cycle. One-quarter of the clock cycle can also be referred to as 90 degrees or π/2 radians. These clock signals can be used in embodiments where each row in pixel array 800 (shown in FIG. 8) performs each of the same tasks in the precharge, read, modify, and write sequence at the same time, though shifted by the phase differences of these clocks. For example, the precharge, read, modify, and write signals of FIG. 7 can be clocked by each of these clocks 700, 710, 720, and 730, resulting in four sets of timing signals phase shifted from each other by one-quarter of a clock cycle. In this example, timing signals 910 shown in FIG. 9 can be timed by each of the clocks 700, 710, 720 and 730 to generate sets of timing signals 910, 912, 914, and 916, respectively. In this way, each series of tasks can be phase shifted by 90 degrees. Each of these sets of timing signals 910, 912, 914, and 916 can be used for one or more rows of pixels 600 (shown in FIG. 6) in pixel array 800. Alternatively, these clock signals can be used to clock different precharge, read, modify, write signals generated by different instances of timing circuits 1000. Either way, resulting supply current spikes 950 can be distributed at four temporal locations throughout each clock cycle. An example is shown in the following figure.

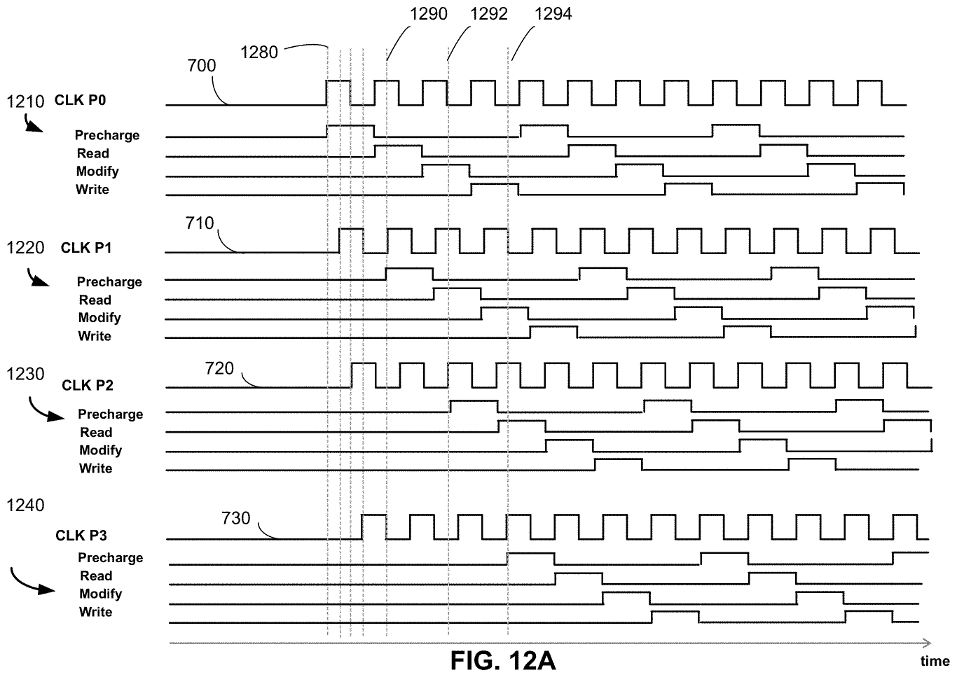

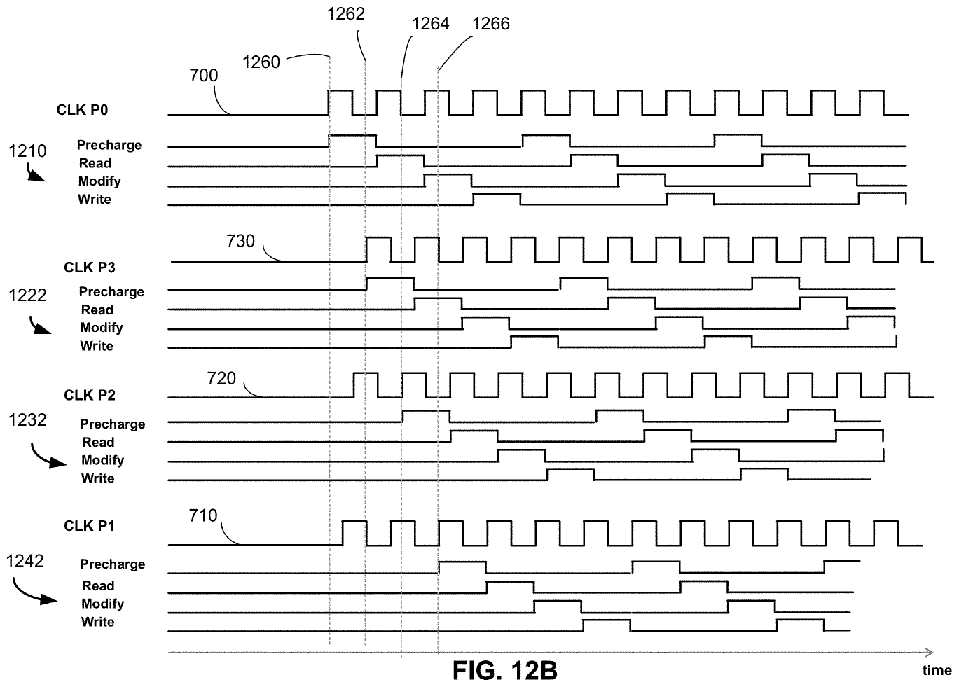

FIG. 12A illustrates a timing diagram for the operation of a pixel array according to an embodiment of the present invention. In this example, timing signals 910, 920, 930, and 940 shown in FIG. 9 can be clocked using the clock signals shown in FIG. 11 to generate timing signals 1210, 1220, 1230, and 1240, respectively. For example, timing signals 910 can be clocked by clock 700 to generate timing signals 1210, which can commence with a precharge pulse at time 1280. Timing signals 920 can be clocked by clock 710, which can be delayed by 90 degrees relative to clock 700, to generate timing signals 1220, which can commence with a precharge pulse at time 1290. Timing signals 930 can be clocked by clock 720, which can be delayed by 180 degrees relative to clock 700 to generate timing signals 1230, which can commence with a precharge pulse at time 1292. Timing signals 940 can be clocked by clock 730, which can be delayed by 270 degrees relative to clock 700 to generate timing signals 1240, which can commence with a precharge pulse at time 1294. In this example, each of the four initial precharge pulses at times 1280, 1290, 1292, and 1294 can be separated by one and one-quarter clock cycles. This is due to the individual clock signals being delayed by one-quarter of a clock cycle and the tasks for each group of timing signals 910, 920, 930, and 940 being delayed by one clock signal. In this way, supply current spikes 950 (shown in FIG. 9), and resulting voltage spikes and transients, from the clocks and the resulting signals can be spread to four temporal locations throughout each clock cycle. This distribution can reduce a peak amplitude of supply current spikes 950.

It should be noted that as a result, the fourth and fifth precharge tasks—the first precharge task of timing signals 1240 and the second precharge task of timing signals 1210—can substantially overlap. Accordingly, embodiments of the present invention can combine the effects of these clock delays and task delays in other ways. An example is shown in the following figure.

FIG. 12B illustrates a timing diagram for the operation of a pixel array according to an embodiment of the present invention. In this example, timing signals shown in FIG. 12A can be clocked using the clock signals shown in FIG. 11 in a different way to generate timing signals 1210, 1222, 1232, and 1242. For example, timing signals 910 can again be clocked by clock 700 to generate timing signals 1210, which can commence with a precharge pulse at time 1260.

These same timing signals can be clocked by clock 730, which can be delayed by 270 degrees relative to clock 700, to generate timing signals 1222, which can commence with a precharge pulse at time 1262. Timing signals 920 can be clocked by clock 720, which can be delayed by 180 degrees relative to clock 700 to generate timing signals 1232, which can commence with a precharge pulse at time 1264. Timing signals 930 can be clocked by clock 710, which can be delayed by 90 degrees relative to clock 700 to generate timing signals 1242, which can commence with a precharge pulse at time 1266. In this example, each of the four initial precharge pulses at times 1260, 1262, 1264, and 1266 can be separated by three-quarters of a clock cycle. In this way, supply current spikes 950 (shown in FIG. 9), and resulting voltage spikes and transients, from the clocks and the resulting signals can be spread to four temporal locations throughout each clock cycle. This distribution can reduce a peak amplitude of supply current spikes 950.

In these and other embodiments of the present invention, either or both the clock and timing signals, including the precharge, read, modify, and write signals, can be skewed in time relative to each other. These skewed signals can be distributed among pixels 600 in a pixel array 800 (shown in FIG. 8) in various ways. An example is shown in the following figure.

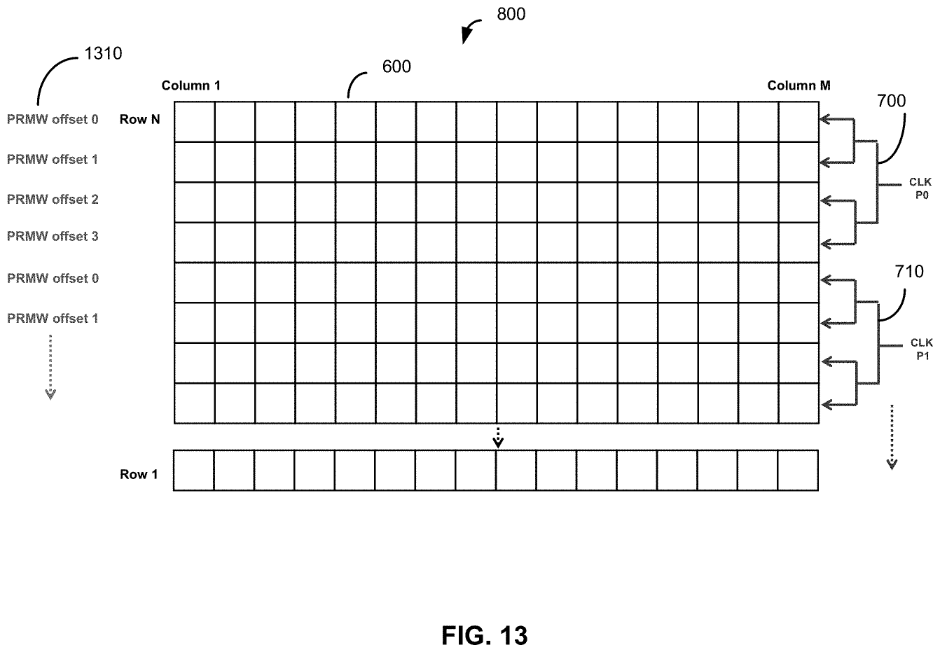

FIG. 13 illustrates an example distribution of clock and timing signals among pixels in a pixel array according to an embodiment of the present invention. In this example, each row of pixels 600 in pixel array 800 can receive the precharge, read, modify, and write signals in a consecutively offset manner as shown in list 1310. A clock signal having a particular phase can clock a group of rows, where different rows in the group of rows have timing signals with different offsets. For example, each of the top four rows can have a different timing signal offset and can be driven by clock 700. In the adjacent group of four rows, each of the rows can have a different timing signal offset, and can be driven by clock 710, where clock 710 is shifted or delayed relative to clock 700 one-quarter of a clock cycle, 90 degrees, or π/2 radians. This pattern can be repeated for clock 720 and clock 730. In this example, clock 700 and clock 710 are shown as being provided to rows of pixels 600 in pixel array 800. In these and other embodiments of the present invention, clock 700, clock 710, clock 720, clock 730, as well as other clocks and other signals, can be distributed using “H-Tree” routing across the pixel array 800. In this way, each of the clocks can be distributed among their corresponding pixels in a balanced way such that the propagation delay through the H-Tree to each pixel is at least similar.

### 7. Positioning Offset Timing Signals and Phase-Shifted Clocks to Simplify Increased Sensitivity

In some circumstances, it can be desirable to increase a sensitivity of pixel array 800 (shown in FIG. 2.) One way of achieving this increased sensitivity is to decrease resolution by joining multiple pixels to act as a single pixel. An example is shown in the following figure.

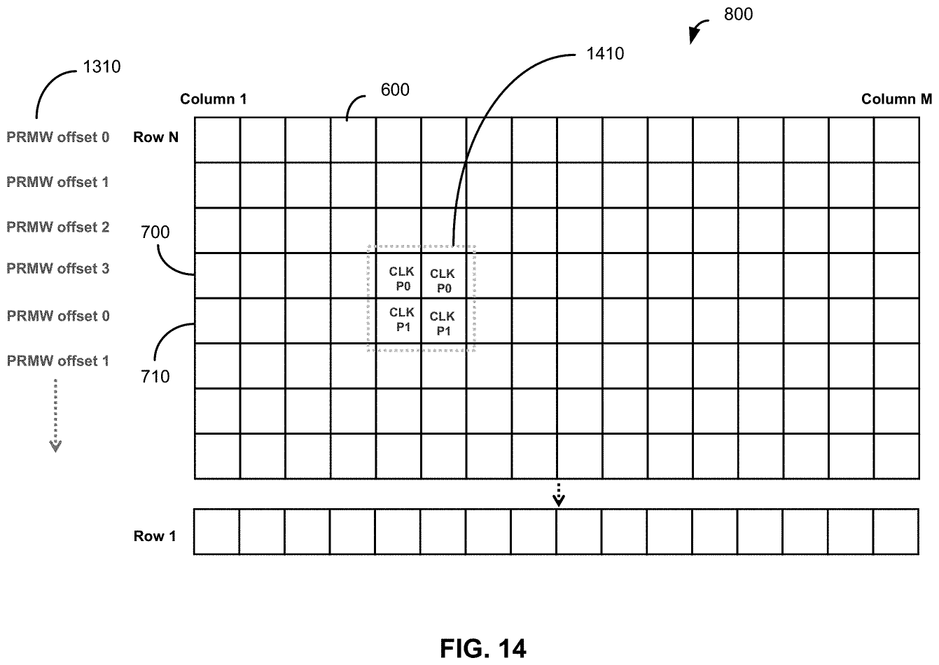

FIG. 14 illustrates a pixel array having an increased sensitivity according to an embodiment of the present invention. In this example, pixels 1410 in pixel array 800 can be treated as a single pixel in order to increase sensitivity at a cost of decreased resolution. Pixels 1410 can include pixels having different offsets between timing signals as shown in list 1310 and they can be clocked by clock signals having different phases, for example one row can be clocked by clock 700 while another can be clocked by clock 710. Accordingly, in order to combine results from these four pixels, compensation for timing signal offsets and clock phase shifts might be needed. The implementation of logic necessary for this task can consume die area and power. Accordingly, embodiments of the present invention can provide arrangements for timing signals and clock signals that can simplify the combination of multiple pixels for increased sensitivity. An example is shown in the following figure.

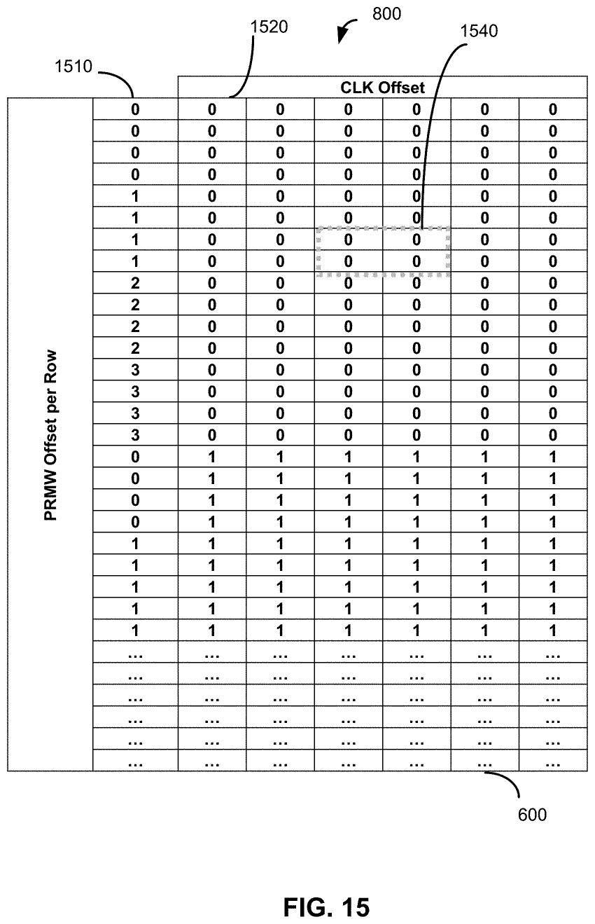

FIG. 15 illustrates an arrangement of timing and clock signals for a pixel array according to an embodiment of the present invention. In this example, each of four adjacent rows of pixels 600 in pixel array 800 can share a set of precharge, read, modify, and write signals, as shown in column 1510. Four rows of each of the offset precharge, read, modify, and write signals can share a clock signal having a common phase, as shown in column 1520. In this way, pixels in group 1540 can be readily combined to increase sensitivity since they share common timing signals and a common clock. That is, pixel array 800 can include circuitry that can combine histogram data collected by multiple pixels 600. For example, pixel array 800 can include circuits that can combined histogram counts from two, four, eight, or different numbers of pixels 600. To facilitate this, multiple rows of pixels 600 in pixel array 800 can share timing signals and clocks. For example, two rows of pixels 600 can share timing signals and clocks as shown in this example. Pixel array 800 can include circuitry for combining the histograms of the pixels in group 1540. The same or similar circuitry can be included across pixel array 800 for similar or different groups of pixels. The combining of the histograms of the pixels in group 1540 can be done external to pixel array 800. Alternatively, it can be done inside the pixel. It can be done on an integrated circuit that includes pixel array 800, or it can be done on an external component, such as an external field-programmable-gate array. The combining can be done in hardware or software. In this way, the sensitivity of pixel array 800 can readily be increase by combining groups of pixels 600. It should again be noted that various arrangements of timing signals and clocks can be provided by these and other embodiments of the present invention.

### 8. Ignoring Bin Counts at Start-up

The above clock phase shift and timing signal offset techniques can be effective at spreading supply current spikes, and resulting voltage spikes, throughout a clock cycle thereby reducing the maximum amplitude of the supply current spikes. During these clock cycles, charge can flow into and out of various distributed capacitances along power supply and signal lines. After several clock cycles, these charge transfers can become somewhat repeatable, with variations occurring due to changes in the logic states of the capacitances being charged and discharged. During initial clock cycles, there can be larger charge transfers until the charge transfers reach this somewhat repeatable pattern. Also, while the clock signals are not running, power consumed by pixel array 800 (shown in FIG. 2) can be minimal. Once the clocks begin running, power consumed by pixel array 800 can increase. This increase in power supply current can cause resistance drops along the power supply and ground lines, thereby effectively reducing power supply voltages and increasing ground voltages. The large initial charge transfers and power supply and ground drops can cause initial histogram results to be in error. An example is shown in the following figure.

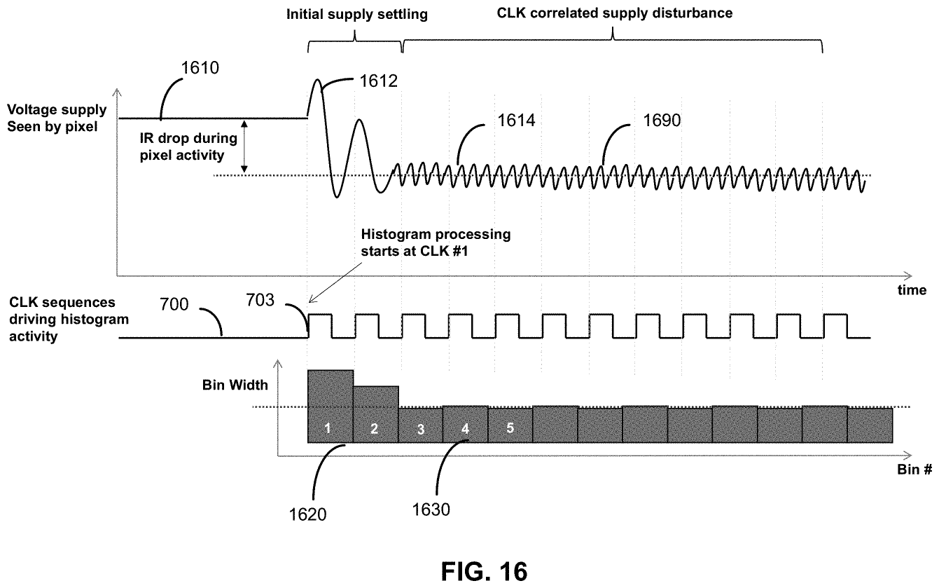

FIG. 16 illustrates initial conditions for a pixel array according to an embodiment of the present invention. Initially, clock 700 does not toggle. At this time pixel array 800 (shown in FIG. 2) consumes little power and accordingly has minimal ground drops (IR drops) along its power supply and ground lines. Accordingly, the effective power supply 1610 seen by a pixel 600 (shown in FIG. 6) can remain high. Clock 700 can toggle beginning at time 703. The toggling of clock 700 can increase power supply and ground currents, which can cause relatively large voltage drops and spikes 1612 in the power supply seen by pixels 600. Accordingly, the amplitude of the voltage supply seen by pixels 600 can drop to level 1614. This can cause a width of bins 1620 to be wider than a width of bins 1630. As a result, histogram counts for bin 1620 can be incorrect. Accordingly, embodiments of the present invention can ignore or suppress the counts for bins 1620 and not begin the histogram process until a later clock cycle, for example the clock cycle associated with counts for bin 1630. An example is shown in the following figure.

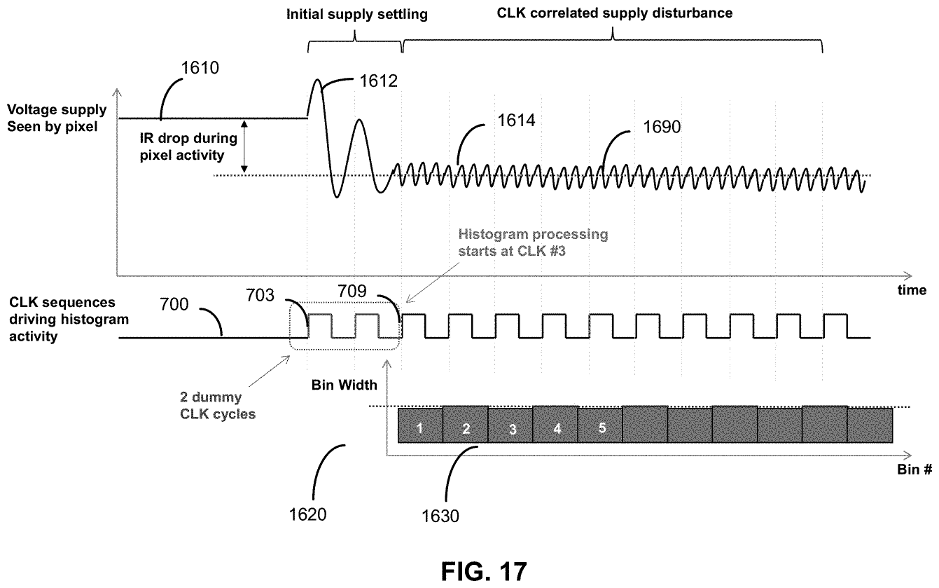

FIG. 17 illustrates initial conditions for a pixel array according to an embodiment of the present invention. In this example, the initial clock cycles beginning at time 703 can be ignored, and the histogram process does not begin until edge 709. In this way bins 1620 can be ignored or suppressed while bins 1630 are utilized in the histogram process. It can also be noted that the supply current spikes 1690 can be reduced as compared to supply current spikes 790 as a result of use of the task offset and clock phase-shift techniques described herein.

In these and other embodiments of the present invention, the number of clock cycles that can be ignored or suppressed can be fixed. Alternatively, the number of clock cycles that can be ignored or suppressed can be programmable. This number can be programmable during manufacturing, during operation of pixel array 800 (shown in FIG. 2), or at other times. A programmable delay circuit that can be programmed to implement a variable number of clock cycles is shown in the following figure.

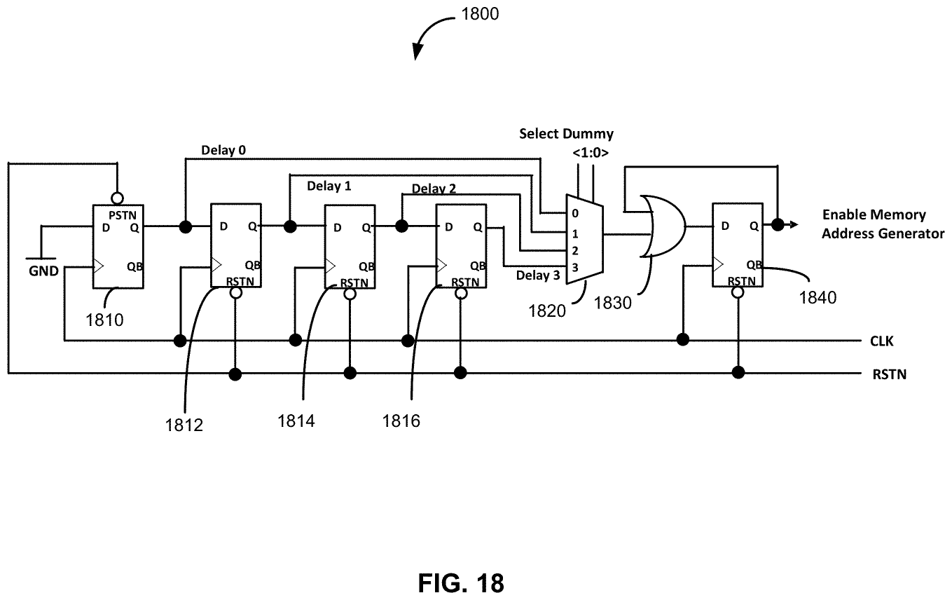

FIG. 18 illustrates a programmable delay circuit that can be programmed for use in suppressing or ignoring a number of initial clock cycles in a pixel array according to an embodiment of the present invention. Programmable delay circuit 1800 can be located in various locations, for example in address generator 620 in pixel 600 (both shown in FIG. 6.) The clock signal on line CLK can be the address generator clock signal received from the timing control circuit 650 on line 654 (both shown in FIG. 6.) In this example, following a reset event where a voltage on line RSTN goes low, an output Q of register 1810 of programmable delay circuit 1800 can go high, while outputs of all of the registers can go low. During a first clock cycle, if input 0 of multiplexer 1820 is selected, the high on the Delay 0 line can pass through multiplexer 1820 and OR gate 1830 to the input of register 1840. Following a first clock rising edge, the Enable Memory Address Generator signal can go high. In this configuration, one clock cycle can be ignored or suppressed. When input 1 of multiplexer 1820 is selected, following the first clock rising edge, output Q of register 1812 can go high and can be received at the input of register 1840. Following a second clock rising edge, the Enable Memory Address Generator signal can go high. In this configuration, two clock cycles can be ignored or suppressed. In these and other embodiments of the present invention, different numbers of clock cycles can be ignored or suppressed using variations of programmable delay circuit 1800. For example, two, five, nine, or 13 clock cycles can be ignored or suppressed using a variation of programmable delay circuit 1800.

### 9. Multiple Lidar Units

Depending on their intended purpose or application, lidar sensors can be designed to meet different field of view (FOV) and different range requirements. For example, an automobile (e.g., a passenger car) outfitted with lidar for autonomous driving might be outfitted with multiple separate lidar sensors including a forward-facing long range lidar sensor, a rear-facing short-range lidar sensor and one or more short-range lidar sensors along each side of the car.

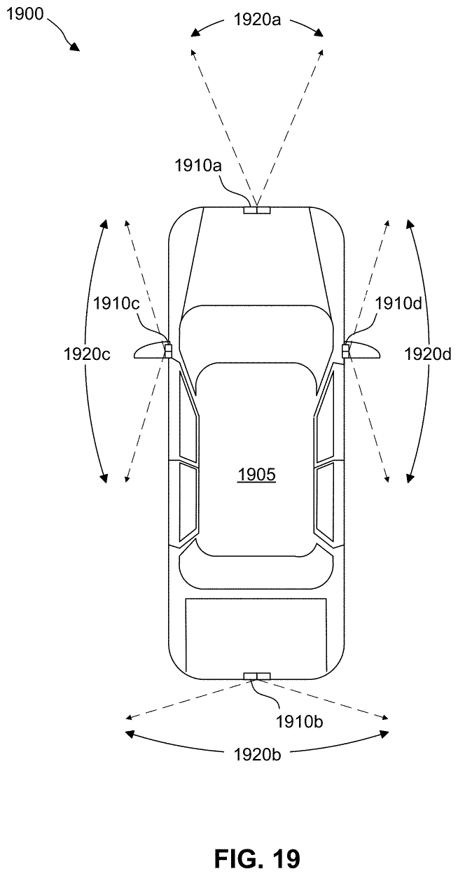

FIG. 19 is a simplified illustration of an automobile 1900 in which four solid-state flash lidar sensors 1910a-d are included at different locations along the automobile. The number of lidar sensors, the placement of the lidar sensors, and the fields of view of each individual lidar sensors can be chosen to obtain a majority of, if not the entirety of, a 360-degree field of view of the environment surrounding the vehicle some portions of which can be optimized for different ranges. For example, lidar sensor 1910a, which is shown in FIG. 19 as being positioned along the front bumper of automobile 1900, can be a long-range (200 meter), narrow field-of-view unit, while lidar sensors 1910b, positioned along the rear bumper, and lidar systems 1910c, 1910d, positioned at the side mirrors, are short-range (50 meter), wide field-of-view systems.

Despite being designed for different ranges and different fields of view, each of the lidar sensors 1910a-1910d can be a lidar system according to embodiments disclosed herein. Indeed, in some embodiments, the only difference between each of the lidar sensors 1910a-1910d is the properties of the diffuser (e.g., diffuser 136). For example, in long range, narrow field-of-view lidar sensor 1910a, the diffuser 136 is engineered to concentrate the light emitted by the emitter array of the lidar system over a relatively narrow range enabling the long-distance operation of the sensor. In the short-range, wide field-of-view lidar sensor 1910b, the diffuser 136 can be engineered to spread the light emitted by the emitter array over a wide angle (e.g., 180 degrees). In each of the lidar sensors 1910a and 1910b, the same emitter array, the same pixel array and the same controller, etc. can be used thus simplifying the manufacture of multiple different lidar sensors tailored for different purposes. Any or all of lidar sensors 1910a-1910d can incorporate the circuits, methods, and techniques for reducing clock induced voltage transients and emissions as described herein.

### 10. Additional Embodiments

In the above detailed description, numerous specific details are set forth to provide a thorough understanding of embodiments of the present disclosure. However, it will be understood by those skilled in the art that the present disclosure can be practiced without these specific details. For example, while various embodiments set forth above described may use SPADs, other detectors can be employed in embodiments. As another example, some of the embodiments discussed above include a specific number of rows and/or columns of sensors or detectors within a sensor. It is to be understood that those embodiments are for illustrative purposes only and embodiments are not limited to any particular number of columns or rows of sensors or detectors within a sensor.

Additionally, in some instances, well-known methods, procedures, components, and circuits have not been described in detail so as not to obscure the present disclosure. It is intended that all embodiments disclosed herein can be implemented separately or combined in any way and/or combination. Aspects described with respect to one embodiment can be incorporated in different embodiments although not specifically described relative thereto. That is, all embodiments and/or features of any embodiments can be combined in any way and/or combination.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A pixel array for use in a lidar system, the pixel array comprising:
a first plurality of pixels to recurringly and consecutively perform a series of tasks; and
a second plurality of pixels to recurringly and consecutively perform the series of tasks,
wherein one of a.) the series of tasks performed by the second plurality of pixels or b.) the series of tasks performed by the first plurality of pixels is offset from the other by a first duration.

2. The pixel array of claim 1 wherein the first duration is a duration allocated for one of the tasks in the series of tasks.

3. The pixel array of claim 1 wherein the first duration is a duration allocated for each of the tasks in the series of tasks.

4. The pixel array of claim 3 wherein a first number of pixels in the first plurality of pixels are clocked by a first clock signal and a second number of pixels in the first plurality of pixels are clocked by a second clock signal, the second clock signal phase-shifted from the first clock signal by a second duration.

5. The pixel array of claim 4 wherein the second duration is one-quarter of a clock cycle.

6. The pixel array of claim 5 wherein the series of tasks comprise precharge, read, modify, and write tasks, and when the second plurality of pixels performs the precharge task, the first plurality of pixels performs the read task.

7. The pixel array of claim 6 wherein pixel array comprises a third plurality of pixels and a fourth plurality of pixels, and when the first plurality of pixels performs the write task, the second plurality of pixels performs the modify task, the third plurality of pixels performs the read task, and the fourth plurality of pixels performs the precharge task.

8. A pixel array for use in a lidar system, the pixel array comprising:
a first plurality of pixels clocked by a first clock signal to recurringly and consecutively perform a series of tasks; and
a second plurality of pixels clocked by a second clock signal to recurringly and consecutively perform the series of tasks,
wherein one of a.) the first clock signal and b.) the second clock signal are delayed relative to the other by a first duration.

9. The pixel array of claim 8 wherein the first duration comprises one-quarter of a clock cycle.

10. The pixel array of claim 9 wherein one of a.) the series of tasks performed by the second plurality of pixels or b.) the series of tasks performed by the first plurality of pixels is offset from the other by a second duration.

11. The pixel array of claim 10 wherein the second duration is a duration allocated for one of the tasks in the series of tasks.

12. The pixel array of claim 10 wherein the second duration is a duration allocated for each of the tasks in the series of tasks.

13. The pixel array of claim 9 wherein a first number of the first plurality of pixels are clocked by the first clock signal to recurringly and consecutively perform the series of tasks and a second number of the first plurality of pixels are clocked by the first clock signal to recurringly and consecutively perform the series of tasks, wherein one of a.) the series of tasks performed by the first number of the first plurality of pixels or b.) the series of tasks performed by the second number of the first plurality of pixels is offset from the other by a second duration.

14. The pixel array of claim 13 wherein the second duration is a duration allocated for each of the tasks in the series of tasks.

15. The pixel array of claim 8 wherein the pixel array comprises a third plurality of pixels and a fourth plurality of pixels, and when the first plurality of pixels performs a write task, the second plurality of pixels performs a modify task, the third plurality of pixels performs a read task, and the fourth plurality of pixels performs a precharge task.

16. The pixel array of claim 15 wherein the third plurality of pixels is clocked by a third clock signal and the fourth plurality of pixels is clocked by a fourth clock signal, and wherein one of a.) the third clock signal and b.) the fourth clock signal are delayed relative to the other by the first duration, wherein the first duration comprises a quarter of a clock cycle.

17. A pixel array for use in a lidar system, the pixel array comprising:
a plurality of pixels configured to generate a plurality of histograms; and
clock circuitry to clock the plurality of pixels while the histograms are generated, wherein a first number of clock cycles are not used by the plurality of pixels before the plurality of pixels begin to generate the plurality of histograms.

18. The pixel array of claim 17 wherein the first number is fixed.

19. The pixel array of claim 17 wherein the first number is programmable.

20. A pixel array for use in a lidar system, the pixel array comprising:
timing circuitry to provide a plurality of groups of timing signals, where each group of timing signals is offset in time relative to the other groups of timing signals;
clock circuitry to provide a plurality of clock signals, where each clock signal is phase-shifted in time relative to the other clock signals;
a first row of pixels;
a second row of pixels, wherein the first row of pixels and the second row of pixels share a same group of timing signals and the same clock signal; and
logic circuitry to combine histogram data from a first pixel in the first row of pixels, a second pixel in the first row of pixels, a third pixel in the second row of pixels, and a fourth pixel in the second row of pixels.

21. The pixel array of claim 20 wherein the first pixel, the second pixel, the third pixel, and the fourth pixel are contiguous.
